(19) United States
(12) Patent Application Publication
(10) Pub. No.: US 2009/0254533 A1
(43) Pub. Date: Oct. 8, 2009

(54) Methods, Systems, and Articles of Manufacture for Distribution of Search Metadata

(76) Inventors: Zachary A. Garbow, Rochester, MN (US); Kevin G. Paterson, San Antonio, TX (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 12/060,986

(22) Filed: Apr. 2, 2008

(51) Int. Cl. G06F 7/06; G06F 15/16; G06F 17/30

(52) U.S. Cl. 707/5; 709/203; 707/102; 707/E17.017

(57) ABSTRACT

Embodiments of the invention are generally related to metadata describing users accessing a network and network content. Each user may have a user profile comprising a list of user tags describing the user. Each item of network content may include a list of content tags describing the item. When a user selects an item of network content, one or more tags from the user profile may be added to the list of content tags for the item. In some embodiments, one or more tags from the list of content tags may be added to the user profile. Therefore, over time and access by multiple users, a comprehensive list of tags describing user profiles and network content may be developed.

### BACKGROUND OF THE INVENTION

1. Field of the Invention

The present invention is generally related to metadata for describing network content.

2. Description of the Related Art

Computers have become an increasingly significant part of human life over the years. Computers have been used not only to make significant strides in science and commerce, but have also proven to be an excellent source of entertainment and a means for connecting persons that may be many thousands of miles apart. For example, by connecting a personal computer to a network such as the Internet, a person may communicate and exchange data with millions of other people connected to the internet. Popular forms of communication include blogging, exchanging images and videos, playing video games, and the like.

With an ever increasing number of people using computers and networks to connect to each other, the amount of network content continues to grow rapidly. Network content such as text, images, videos, and the like, may be stored in a server or any other storage space that is retrievable by persons connected to the network. For example, a person may access a search engine and enter search criteria for retrieving desired content. Each unit of data on the network may generally include one or more descriptive tags associated therewith. The tags are included by a person uploading the content to the network in order to facilitate searching and retrieving the content.

### SUMMARY OF THE INVENTION

The present invention is generally related to metadata for describing network content.

One embodiment of the invention provides a method for describing content on a network. The method generally comprises providing one or more items of network content to a user having a user profile comprising a list of user tags describing the user, wherein each item of network content has a list of content tags describing the item. The method further comprises receiving an indication of selection of an item of the one or more items of network content provided, and adding one or more user tags from the user profile to the list of content tags for the selected item in response to the receiving the indication of selection.

Another embodiment of the invention provides a computer readable storage medium comprising a program product which, when executed by a processor, is configured to perform an operation for describing content on a network. The operation generally comprises providing one or more items of network content to a user having a user profile comprising a list of user tags describing the user, wherein each item of network content has a list of content tags describing the item. The operation further comprises receiving an indication of selection of an item of the one or more items of network content provided, and in response to receiving the indication of selection, adding one or more user tags from the user profile to the list of content tags for the selected item.

Yet another embodiment of the invention provides a system, generally comprising memory and a processor communicably coupled with the memory. The memory generally comprises one or more user profiles, wherein each user profile comprises a list of user tags describing a user, one or more content profiles, wherein each content profile comprises a list of content tags describing an item of content available on a network, and a program configured to alter the user tags and content tags to more accurately describe users and the content. The program, when executing the program, is generally configured to provide one or more items of network content to a user, receive an indication of selection of an item of the one or more items of network content provided, and in response to receiving the indication of selection, add one or more user tags from a user profile associated with the user to the list of content tags for the selected item.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates an exemplary system according to an embodiment of the invention.

FIG. 2 illustrates an exemplary user profile according to an embodiment of the invention.

FIG. 3 illustrates an exemplary content profile according to an embodiment of the invention.

FIG. 4A illustrates an exemplary user profile after cross pollination, according to an embodiment of the invention.

FIG. 4B illustrates an exemplary content profile after cross pollination, according to an embodiment of the invention.

FIG. 5 is a flow diagram of exemplary operations performed during cross pollination, according to an embodiment of the invention.

FIG. 6 is a flow diagram of exemplary operation performed to update weights associated with tags, according to an embodiment of the invention.

### DETAILED DESCRIPTION OF THE PREFERRED EMBODIMENTS

The present invention is generally related to metadata describing users accessing a network and network content. Each user may have a user profile comprising a list of user tags describing the user. Each item of network content may include a list of content tags describing the item. When a user selects an item of network content, one or more tags from the user profile may be added to the list of content tags for the item. In some embodiments, one or more tags from the list of content tags may be added to the user profile. Therefore, over time and access by multiple users, a comprehensive list of tags describing user profiles and network content may be developed.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

One embodiment of the invention is implemented as a program product for use with a computer system. The program(s) of the program product defines functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive) on which information is permanently stored; (ii) writable storage media (e.g., floppy disks within a diskette drive or hard-disk drive) on which alterable information is stored. Such computer-readable storage media, when carrying computer-readable instructions that direct the functions of the present invention, are embodiments of the present invention. Other media include communications media through which information is conveyed to a computer, such as through a computer or telephone network, including wireless communications networks. The latter embodiment specifically includes transmitting information to/from the Internet and other networks. Such communications media, when carrying computer-readable instructions that direct the functions of the present invention, are embodiments of the present invention. Broadly, computer-readable storage media and communications media may be referred to herein as computer-readable media.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

As network content continues to grow, it has become increasingly difficult to categorize the vast amounts of data available on a network. One method for categorizing network content involves including descriptive tags for each piece of data available on the network. For example, an image of George W. Bush may include a tag “President.” A search engine may utilize the tags to determine content that is relevant to particular search criteria. For example, a user may launch a search engine such as, for example, the Google or yahoo search engine, and type in the word “President” in a text box for entering search criteria. In response to the user's search for the word “President”, the search engine may display a link to the aforementioned image of George W. Bush along with any other content that includes a tag “President”.

While tags provide a useful method of categorizing content, a person uploading content may not accurately categorize the content. In other cases, a person uploading content may not include all possible tags for describing the content, thereby making it difficult to retrieve the content. For example, a person may upload an image of Al Gore and include a tag “Vice President” for the image. However, a search for the term “Nobel Laureate” may not retrieve the image of Al Gore because such a tag was not included by the person uploading the image. Therefore, comprehensively and accurately categorizing content using tags may require a lot of thought, time, and effort on the part of a person uploading the content.

Embodiments of the invention provide a means for automatically including tags for content based on access of the content on a network. For example, each user on a network may have a user profile comprising one or more tags describing the user. In some embodiments, the user profile may comprise tags describing the user's interests. When the user accesses content the user's tags may pollinate the tags of the content. In other words, the user's tags may be added to the content tags. In some embodiments, the content tags may pollinate a user's tags. Therefore, over time, a more meaningful and more comprehensive set of tags may develop for the content and for users.

### EXEMPLARY SYSTEM

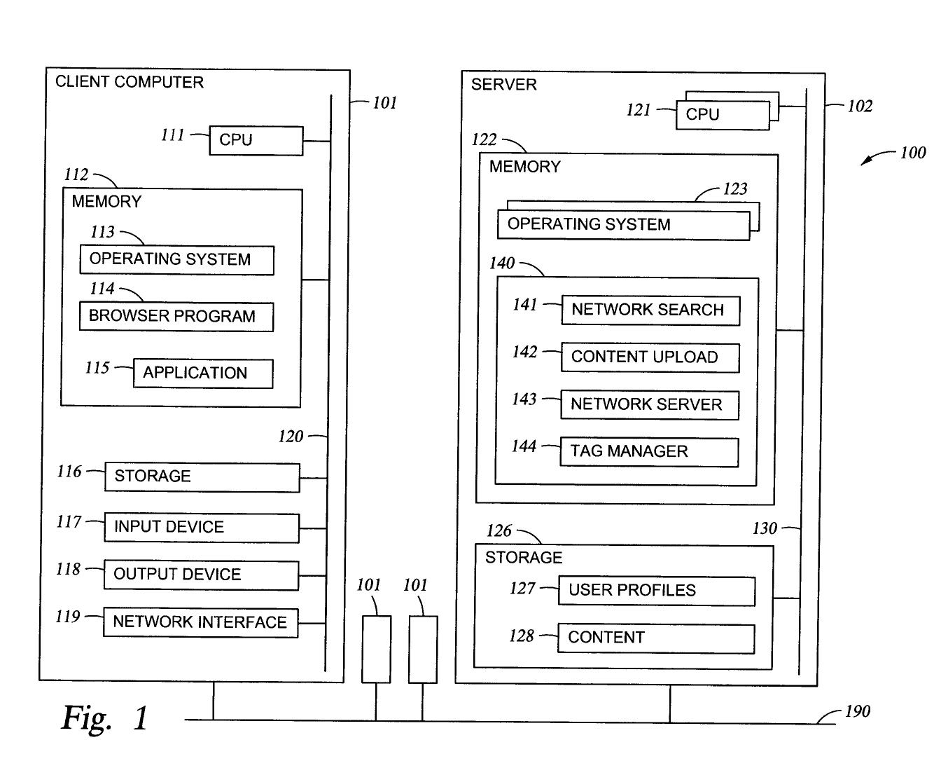

FIG. 1 depicts a block diagram of a networked system 100 in which embodiments of the invention may be implemented. In general, the networked system 100 includes a client (e.g., user's) computer 101 (three such client computers 101 are shown) and at least one server 102 (one such server 102 shown). The client computers 101 and server 102 are connected via a network 190. In general, the network 190 may be a local area network (LAN), a metropolitan area network (MAN), a wide area network (WAN), or the like. In a particular embodiment, the network 190 is the Internet.

The client computer 101 includes a Central Processing Unit (CPU) 111 connected via a bus 120 to a memory 112, storage 116, an input device 117, an output device 118, and a network interface device 119. The input device 117 can be any device to give input to the client computer 101. For example, a keyboard, keypad, light-pen, touch-screen, track-ball, or speech recognition unit, audio/video player, and the like could be used. The output device 118 can be any device to give output to the user, e.g., any conventional display screen. Although shown separately from the input device 117, the output device 118 and input device 117 could be combined. For example, a display screen with an integrated touch-screen, a display with an integrated keyboard, or a speech recognition unit combined with a text speech converter could be used.

The network interface device 119 may be any entry/exit device configured to allow network communications between the client computers 101 and server 102 via the network 190. For example, the network interface device 119 may be a network adapter or other network interface card (NIC).

Storage 116 is preferably a Direct Access Storage Device (DASD). Although it is shown as a single unit, it could be a combination of fixed and/or removable storage devices, such as fixed disc drives, floppy disc drives, tape drives, removable memory cards, or optical storage. The memory 112 and storage 116 could be part of one virtual address space spanning multiple primary and secondary storage devices.

The memory 112 is preferably a random access memory sufficiently large to hold the necessary programming and data structures of the invention. While memory 112 is shown as a single entity, it should be understood that memory 112 may in fact comprise a plurality of modules, and that memory 112 may exist at multiple levels, from high speed registers and caches to lower speed but larger DRAM chips.

Illustratively, the memory 112 contains an operating system 113. Illustrative operating systems, which may be used to advantage, include Linux (Linux is a trademark of Linus Torvalds in the US, other countries, or both) and Microsoft's Windows®. More generally, any operating system supporting the functions disclosed herein may be used.

Memory 112 may include a browser program 114 which, when executed by CPU 111, provides support for browsing content available at a server 102 or another client computer 101. In one embodiment, browser program 114 may include a web-based Graphical User Interface (GUI), which allows the user to display Hyper Text Markup Language (HTML) information. In one embodiment, the GUI may be configured to allow a user to create a search string, request search results from a server 102 or client computer 101, and display search results. More generally, however, the browser program 114 may be a GUI-based program capable of rendering any information transferred from a client computer 101 and/or server 102. Memory 112 is also shown comprising an application 115. Application 115 may be configured to facilitate creation of user profiles, as described in greater detail below.

The server 102 may by physically arranged in a manner similar to the client computer 101. Accordingly, the server 102 is shown generally comprising at least one CPU 121, memory 122, and a storage device 126, coupled with one another by a bus 130. Memory 122 may be a random access memory sufficiently large to hold the necessary programming and data structures that are located on server 102.

In one embodiment, server 102 may be a logically partitioned system, wherein each logical partition of the system is assigned one or more resources, for example, CPUs 121 and memory 122, available in server 102. Accordingly, server 102 may generally be under the control of one or more operating systems 123 shown residing in memory 122. Each logical partition of server 102 may be under the control of one of the operating systems 123. Examples of the operating system 123 include IBM OS/400®, UNIX, Microsoft Windows®, and the like. More generally, any operating system capable of supporting the functions described herein may be used.

The memory 122 further includes one or more applications 140. The applications 140 may be software products comprising a plurality of instructions that are resident at various times in various memory and storage devices in the computer system 100. When read and executed by one or more processors 121 in the server 102, the applications 140 may cause the computer system 100 to perform the steps necessary to execute steps or elements embodying the various aspects of the invention.

In one embodiment of the invention, the applications 140 may include a network search program 141 configured to search, collect, and provide network content in response to a request received from a client computer 101. For example, the network search program 141 may be a search engine. In one embodiment, a user may launch the browser program 114 at a client computer 101 and enter search criteria for network content. The search criteria may be received by the network search program 141 at a server 102. In response to receiving the search criteria, network search program 141 may retrieve web content relevant to the search criteria from the server 102, another server 102, or any client computer 101 connected to the network 190. In one embodiment, the network content may be retrieved for example, from a storage device 126 of a server 102 or a storage device 116 of a client computer 101 by the network program 141. The retrieved network content may be transferred to the requesting client computer 101 and displayed in a graphical user interface.

Network content may also be uploaded from a client computer 101 to a server 102. For example, a user may launch the browser program 114 and upload an image to a server 102. The image may be received by a content upload program 142 at the server 102. The content upload program 142 may store the image at the server 102 so that the image available to requesting network entities. The network content may include one or more associated descriptive tags created by the user. The tags created by a person uploading the content are hereinafter referred to as inherent tags. In some embodiments, a user may choose not to include inherent tags for uploaded content. The uploaded content and any associated inherent tags may be placed in storage at the server 102, for example, in the storage device 126.

While exchanging content with a server 102 is described herein, embodiments of the invention are not limited to communications between a client computer 101 and server 102. In other embodiments, network content may be stored or retrieved from one client computer to another client computer. Accordingly, in some embodiments, the client computers 101 may also include one or more applications 140 to facilitate receiving requests associated with content. The content and associated tags may be stored in a storage device at the client computer, for example in a storage device 116.

As suggested earlier, a user may or may not include inherent tags while uploading content. With the exploding amounts of content uploaded on to a network, users find it difficult to provide a comprehensive, complete, and accurate list of tags for each piece of data uploaded. Therefore, uploaded content may not be properly characterized. Embodiments of the invention allow automatic creation of new tags for content on a network based on user access of the content.

In one embodiment of the invention, each user may be allowed to create a user profile. The user profile may contain one or more tags associated with the user. For example, in a particular embodiment, a user may have tags describing the user's interests such as, for example, “Mountain Biking”, “Guitar”, “Sports”, and the like.

In some embodiments of the invention, the user profiles may be created as a part of a network service. Therefore, the user profiles may be accessible to any requesting entity on the network. For example, a network service program 143 may be included among applications 140 of a server 102. Accordingly, in one embodiment, network service application 143 may be configured to generate one or more Graphical User Interface (GUI) screens to allow a user at a client computer 101 to create a user profile and enter one or more tags for the user profile. The user profiles and associated tags may be stored in a storage device 126 of the server 102, as illustrated in FIG. 1.

In alternative embodiments, client computers 101 may include a application 115 such as a network service configured to generate GUI screens to allow a user to create a user profile and associate tags with the profile. In such embodiments, the user profiles and tags may be stored in a storage device 116 at the client computer 101.

Applications 140 at server 102 may also include a tag manager 144. Tag manager 144 may be configured to add, remove, or otherwise edit tags for user profiles and/or network content to develop a more comprehensive and accurate list of tags for the user profiles and/or network content, as will be described below.

### Cross Pollination of Resource Tags

Embodiments of the invention provide a method for categorizing network content based on user access of content. In one embodiment, selection of network content by a user may cause one or more tags of the user's profile to be included in the tags for the content. Furthermore, in other embodiments, the tags associated with the content may be included in the tags for the user profile. In some embodiments, the tags for the user profiles and the network content may be removed after a predetermined period of time if a correlation between the tag and the content/user profile is weak. Therefore, over time, a comprehensive, accurate categorization of network content may be achieved.

A user profile may include a plurality of fields of data describing a user including, for example, user name, sex, date of birth, marital status, location, and the like. Additionally, each user profile may include one or more tags for describing the user. For example, in a particular embodiment, the user tags may describe the user's interests. In one embodiment of the invention, the tags may be classified into one or more categories. For example, the tags may include inherent tags and inherited tags. Inherent tags may be tags created by the user, for example, at the time the user profile is created. Furthermore, the inherent tags may be modified, for example, by adding, deleting, or editing the tags by the user at any time. Inherited tags may be tags inherited by the user profile through interaction with network content.

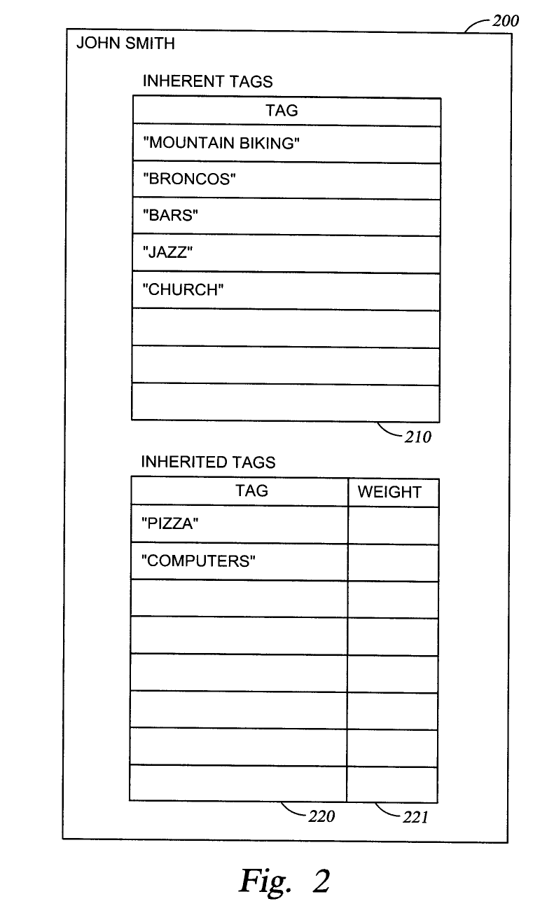

FIG. 2 illustrates descriptive tags of an exemplary user profile 200 for a hypothetical person named John Smith. As illustrated in FIG. 2, user profile 200 may include inherent tags 210 and inherited tags 220. Exemplary inherent tags illustrated in FIG. 2 include, for example, “Mountain Biking”, “Broncos”, “Bars”, “Jazz”, and “Church”. Exemplary inherited tags 220 included in FIG. 2 include “Pizza” and “Computers”. As illustrated in FIG. 2, each inherited tag may have an associated weight value indicated in weight column 221. In one embodiment, the weight for each inherited tag may indicate a correlation of the tag to the user profile. The determination of weights is described in greater detail below.

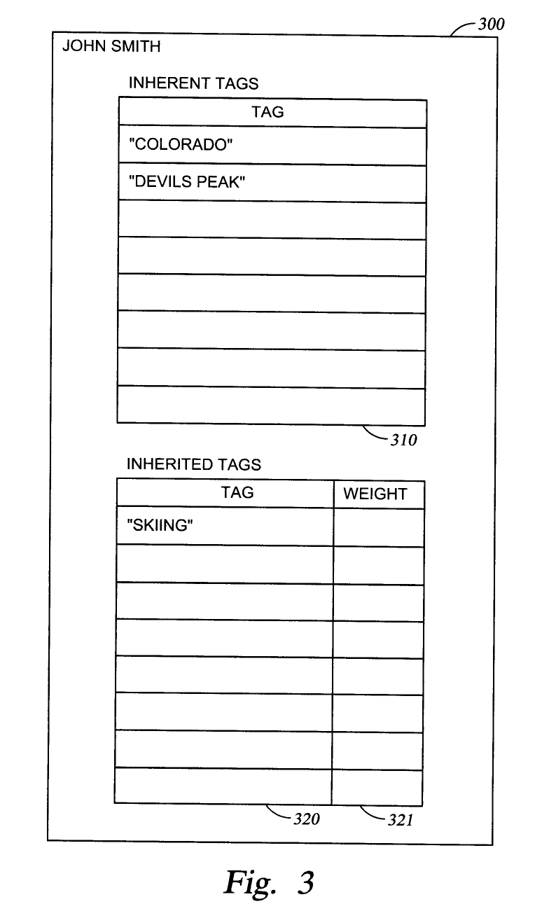

FIG. 3 illustrates exemplary tags for network content 300 according to an embodiment of the invention. Web content may include any piece of information uploaded on to a network, for example, text, images, files, documents, videos, links, and the like. As illustrated in FIG. 3, one or more tags may be associated with each piece of data uploaded on to a network. In some embodiments, content tags may also be organized into one or more categories. For example, FIG. 3 illustrates inherent tags 310 and inherited tags 320 for network content 300. The inherent tags 310 may be tags included by a person uploading the network content 300. Inherent tags 310 may be modified, added, and/or deleted by the user or an owner of the network content 300.

For purposes of illustration network content 300 is assumed to be an image of a mountain in Colorado. Accordingly, the inherent tags may include one or more tags describing the mountain such as, for example, “Colorado” and “Devil's Peak”, as illustrated in FIG. 3.

The inherited tags 320 may include tags that are inherited from one or more user profiles. For example, inherited tags 320 include a tag “Skiing”, which may have been added from a profile of a user who accessed the image 300 and had an associated user profile containing the tag “Skiing”. Further, as illustrated in FIG. 3, each inherited tag 320 may include an associated weight value indicated in weight column 321. The weight may indicate a correlation between the image 300 and an associated tag 320.

In one embodiment of the invention, when a user selects a particular piece of data available on the network, one or more tags in the user profile may be included as inherited tags of the piece of data. For example, the user John Smith may submit a search string, for example, “Colorado” to a search engine. Searching for the word “Colorado” may display a link to the image 300. If the user John Smith clicks the link to the image 300, one or more tags associated with user profile 200 may be included in the inherited tags 320 of the image 300. In some embodiments, one or more tags associated with image 300 may be included in the inherited tags 220 of the user profile 200.

The transfer of user profile tags into network content tags and the inclusion of network content tags into user profile tags is generally referred to hereinafter as pollination of tags. If pollination occurs in both directions, i.e., from user profile to network content and from network content to the user profile, then the transfer is referred to hereinafter as cross-pollination.

By allowing for the pollination of tags, network content and use profiles may develop a comprehensive list of descriptive tags over time and multiple accesses by different users. For example, the mountain illustrated in image 300 may provide trails for mountain biking. However, the person uploading the image 300 may not have included a tag directed to mountain biking. If user John Smith selects the image 300, the “Mountain Biking” tag from the inherent tag 210 of user profile 200 may be included in the inherited tags 320 of image 300. Therefore, the descriptive tags for the mountain depicted in image 300 become more comprehensive.

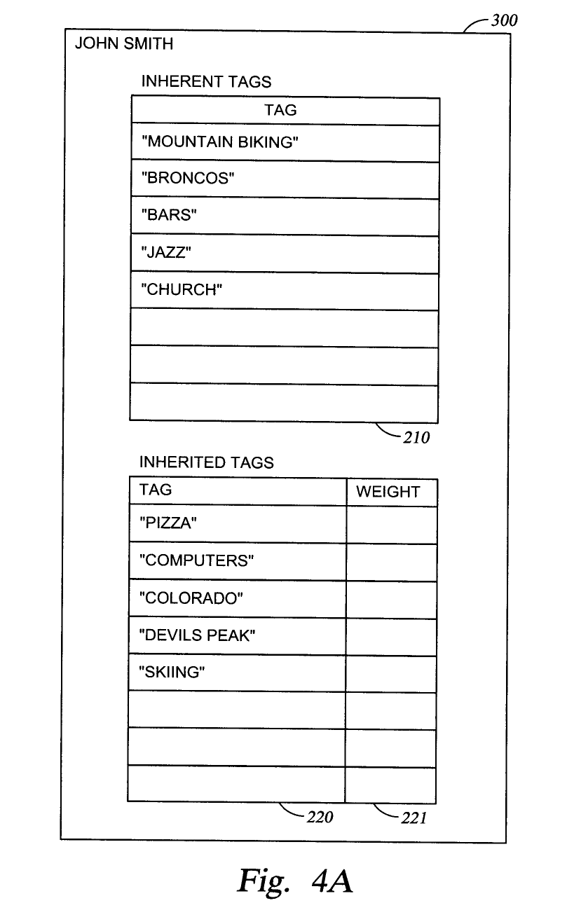

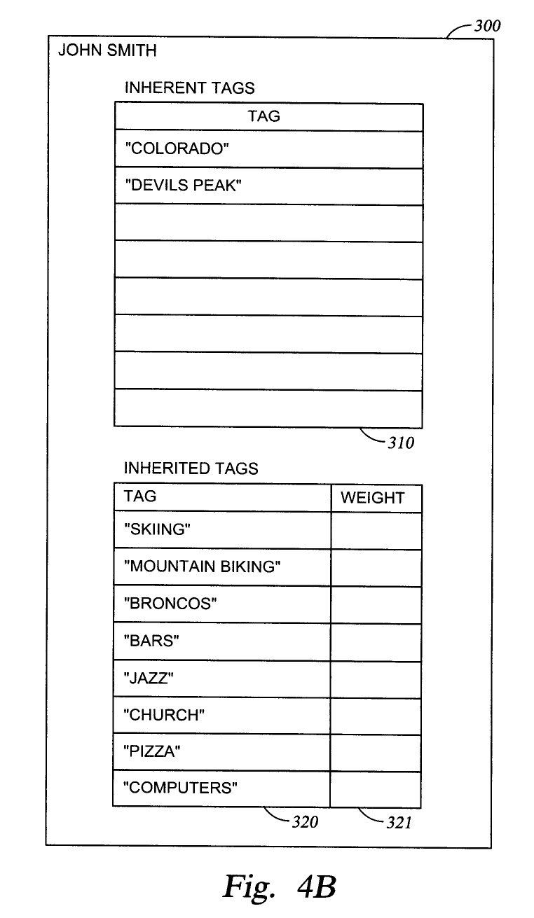

FIGS. 4A and 4B illustrate tags in the user profile 200 and the image 300 after cross pollination. As illustrated in FIG. 4A, user profile 200 now includes the tags 310 and 320 of image 300. Similarly, as illustrated in FIG. 4B, image 300 now includes the inherent tags 210 and inherited tags 320 from user profile 200. Therefore, by transferring user profile tags to network content, a more comprehensive list of tags for the content may be developed without any effort on the part of network users.

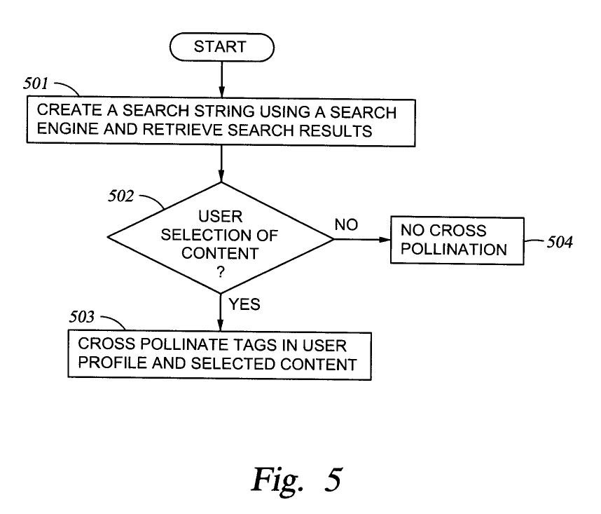

FIG. 5 illustrates a flow diagram of exemplary operations that may be performed during cross pollination of tags. The operations may begin in step 501 when a user searches for network content. For example, a user may launch the browser program 114 and enter a search string. The search string may be received by the network search program 141 at a server 102 (see FIG. 1), which may retrieve results based on the search string. In one embodiment, the results may comprise one or more links to network content relevant to the search criteria displayed on a GUI screen by the browser program 114.

In step 502, a tag manager 144 may determine whether the user has selected a link associated with particular network content. If the user selects a link, tag manager 144 may cross pollinate the tags associated with the user profile and the content in step 503, as illustrated in FIG. 5. For example, the tag manager 144 may access a user profile and content profile from a storage location in a server 102 or client 101 and cross pollinate the tags contained therein. In alternative embodiments, the tag manager may only pollinate the content with tags from the user profile. If, on the other hand, the user does not select any content, no cross pollination is performed, as illustrated in step 504.

While it is likely that users will interact with content that is related to their interest, it is also possible that one or more tags in the user profile is not relevant to a particular piece of accessed data. For example, referring to FIG. 4B, “Mountain Biking” may be relevant to the image 300, however, “Bars” may not be relevant. In one embodiment of the invention, the weight value associated with inherited tags may indicate a correlation between the tag and a user profile or network content. Therefore, in some embodiments, the weight may be used to determine whether a particular inherited tag should remain associated with the profile or content.

In one embodiment, the weight value for an inherited tag may be a numerical value that is calculated based on a number of times that the tag is inherited. For example, several users may have a “Mountain Biking” tag in their respective user profiles. If one or more of the several users select the image 300, the weight value of the “Mountain Biking” tag in the inherited tags 320 of the image 300 may also be incremented based on the number of users selecting the image. For example, each time a user selects the image, the weight of the “Mountain Biking” tag in the inherited tags 320 may be incremented by a predetermined amount. Incrementing the weight value is disclosed herein only as an example. Any reasonable type and number of mathematical operations may be performed based on the number of users accessing network content to determine the weight. The altering of inherited tag weights based on user access is hereinafter referred to as strengthening tags.

In one embodiment of the invention, if the weight of a particular tag does not reach a threshold value after a predetermined period of time, the tag manager 144 may remove the tag from inherited tag list 320 of the image 300. For example, if the weight of the “Bars” tag is not at a threshold value at the end of a predetermined period of time, the “Bars” tag may be removed.

In still other embodiments, if the weight of a tag is not strengthened by a predetermined amount in a predetermined amount of time, the weight of the tag may be reduced by a predetermined amount. For example, in a particular embodiment, if the weight of a tag is not strengthened to a predetermined amount by a predetermined amount of time, the weight of the tag may be decremented by a predetermined amount. Decreasing the correlation between the tag and content is hereinafter referred to as weakening the tag.

In one embodiment of the invention, the weight of an inherited tag may depend on the nature of an interaction between a user and the network content. For example, if a user clicks a link to view the image 300, the tags inherited by the image 300 from the user profile 200 may be adjusted to a first value. If the user John Smith saves the image 300, the weight of tags inherited from the user profile 300 may be adjusted to a second value. Saving an image or other content may indicate a stronger correlation between inherited tags and network content in comparison to simply viewing the content. Therefore, in some embodiment, saving the content may strengthen the weight much more than simply viewing the content.

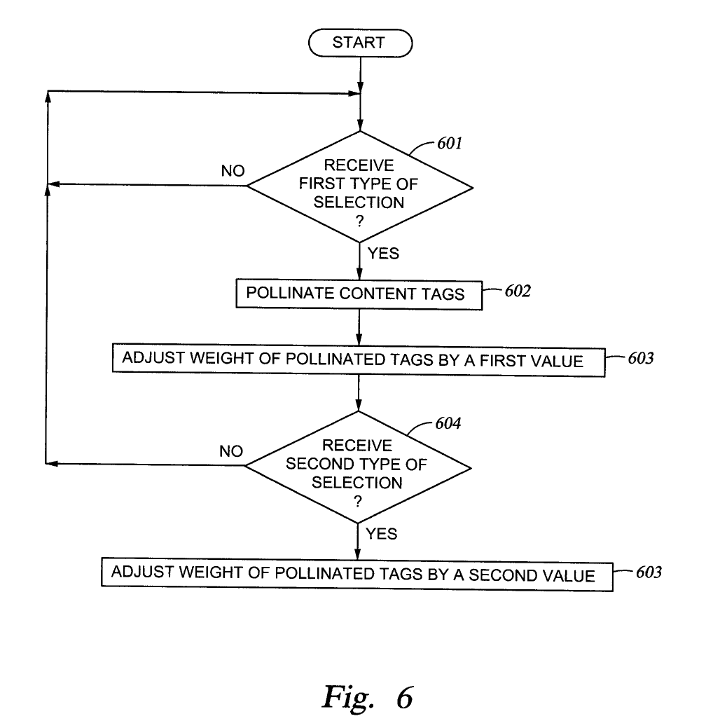

FIG. 6 illustrates a flow diagram of exemplary operations performed by the tag manager 144 during pollination of tags, wherein the pollination is based on the nature of an interaction between a user and network content. The operations may begin in step 601 by determining whether a first type of selection of the content has occurred. In one embodiment, the first type of selection may correspond to a user selecting a link associated with the content. If the link is selected, the tag manager may be configured to pollinate tags with the content with tags from a user profile in step 602. In step 603, the tag manager may adjust the weight of the pollinated tags by a first value, wherein adjusting the weight by the first value strengthens the correlation of the tag to the content.

In step 604, the tag manager 144 may determine whether a second type of selection of the content has occurred. In one embodiment of the invention, the second type of selection may correspond to a user saving the content on to their respective client computer 101. If the second type of selection occurs, the tag manager may be configured to adjust the weight of the tags of the content by a second amount in step 605, wherein adjusting the weight by the second value further strengthens the correlation of the tags to the content.

While viewing and saving are described herein as types of interactions between a user and content, embodiments of the invention are not so limited. Any number and types of interaction between a user and content can be defined based on user actions and/or the particular type of content. For example, the weight adjustment may depend on a length of time for which the content is viewed, modification of the content by the user, and the like.

In one embodiment of the invention, pollination of tags may involve pollination of only a predetermined amount or types of tags. For example, in a particular embodiment, only a predetermined number of tags having the strongest correlation, based on weight, to a user profile may pollinate network content, or vice versa, thereby pollinating with only the most relevant tags. In some embodiment, only the inherent tags of a user profile may be used during pollination of content tags.

In some embodiments of the invention, if an inherited tag achieves a predetermined correlation based on an associated weight to a respective content or user profile, the inherited tag may be converted to an inherent tag. For example, if a predetermined number of users having a tag “Mountain Biking” in their respective profiles access the image 300, the “Mountain Biking” tag may be included as an inherent tag of image 300. In other embodiments, an inherent tag may be converted to an inherited tag if the correlation between the inherent tag and the content or user profile is determined to be weak. For example, in one embodiment, if the weight of an inherent tag does not achieve a predetermined weight in a predetermined amount of time, the inherent tag may be converted to an inherited tag.

While the examples provided above discuss strengthening and weakening tags for network content, similar operations may be performed by the tag manager 144 to strengthen, weaken, add, remove, or otherwise modify tags associated with user profiles.

In one embodiment of the invention, a user may be able to selectively enable or disable pollination of tags. For example, the user may selectively enable or disable pollination of network content by the user's profile. Alternatively, the user may be allowed to selectively enable/disable pollination of the user's profile by network content.

In some embodiments, the user may be able to selectively enable or disable pollination as described above based on the type of content or by the content provider. For example, the user may enable pollination for images, but disable pollination for videos. In another example, the user may enable/or disable pollination for content provided by a particular provider, such as, for example, a website.

By allowing cross pollination of tags between user profiles and network content, embodiments of the invention facilitate development of a more comprehensive list of descriptive tags for the user profiles and network content. Therefore, the user profiles and network content may more easily be retrieved by users seeking desired content on the network.

While the foregoing is directed to embodiments of the present invention, other and further embodiments of the invention may be devised without departing from the basic scope thereof, and the scope thereof is determined by the claims that follow.

What is claimed is:

1. A method for describing content on a network, comprising:
providing one or more items of network content to a user having a user profile comprising a list of user tags describing the user, wherein each item of network content has a list of content tags describing the item;
receiving an indication of selection of an item of the one or more items of network content provided; and
in response to receiving the indication of selection, adding one or more user tags from the user profile to the list of content tags for the selected item.

2. The method of claim 1, further comprising providing the one or more items of network content to the user in response to receiving a query from the user, wherein the one or more items provided are retrieved based on the query.

3. The method of claim 1, further comprising, in response to receiving the indication of selection, adding one or more content tags from the list of content tags to the list of user tags.

4. The method of claim 3, wherein the list of content tags and the list of user tags each comprise one or more inherent tags, wherein the inherent tags comprise tags included at a time of creation of respective content and user profile.

5. The method of claim 4, further comprising converting an inherent tag to an inherited tag based on a correlation between the inherent tag and one of the user profile and network content, wherein the inherited tags comprise one of the added one or more user tags and the added one or more content tags.

6. The method of claim 5, further comprising converting an inherited tag to an inherent tag based on a correlation of the inherited tag to one of the user profile and network content.

7. The method of claim 4, wherein adding one or more user tags from the user profile to the list of content tags for the selected item comprises adding the inherent tags of the user profile to the list of content tags.

8. The method of claim 4, wherein adding one or more content tags from the list of content tags to the list of user tags comprises adding the inherent tags of the selected item to the list of user tags.

9. A computer readable storage medium comprising a program product which, when executed by a processor, is configured to perform an operation for describing content on a network, comprising:
providing one or more items of network content to a user having a user profile comprising a list of user tags describing the user, wherein each item of network content has a list of content tags describing the item;
receiving an indication of selection of an item of the one or more items of network content provided; and
in response to receiving the indication of selection, adding one or more user tags from the user profile to the list of content tags for the selected item.

10. The computer readable storage medium of claim 9, wherein the operation further comprises providing the one or more items of network content to the user in response to receiving a query from the user, wherein the one or more items provided are retrieved based on the query.

11. The computer readable storage medium of claim 9, wherein the operation further comprises, in response to receiving the indication of selection, adding one or more content tags from the list of content tags to the list of user tags.

12. The computer readable storage medium of claim 11, wherein the list of content tags and the list of user tags each comprise one or more inherent tags, wherein the inherent tags comprise tags included at a time of creation of respective content and user profile.

13. The computer readable storage medium of claim 12, the operation further comprising converting an inherent tag to an inherited tag based on a correlation between the inherent tag and one of the user profile and network content, wherein the inherited tags comprise one of the added one or more user tags and the added one or more content tags.

14. The computer readable storage medium of claim 13, the operation further comprising converting an inherited tag to an inherent tag based on a correlation of the inherited tag to one of the user profile and network content.

15. The computer readable storage medium of claim 12, wherein adding one or more user tags from the user profile to the list of content tags for the selected item comprises adding the inherent tags of the user profile to the list of content tags.

16. The computer readable storage medium of claim 12, wherein adding one or more content tags from the list of content tags to the list of user tags comprises adding the inherent tags of the selected item to the list of user tags.

17. A system, comprising:
memory comprising:
one or more user profiles, wherein each user profile comprises a list of user tags describing a user;
one or more content profiles, wherein each content profile comprises a list of content tags describing an item of content available on a network; and
a program configured to alter the user tags and content tags to more accurately describe users and the content; and
a processor communicably coupled with the memory which, when executing the program, is configured to:
provide one or more items of network content to a user;
receive an indication of selection of an item of the one or more items of network content provided; and
in response to receiving the indication of selection, add one or more user tags from a user profile associated with the user to the list of content tags for the selected item.

18. The system of claim 17, wherein the processor is further configured to provide the one or more items of network content to the user in response to receiving a query from the user, wherein the one or more items provided are retrieved based on the query.

19. The system of claim 17, wherein the processor is further configured to add one or more content tags from the list of content tags to the list of user tags of the user's user profile.

20. The system of claim 18, wherein the list of content tags and the list of user tags each comprise one or more inherent tags, wherein the inherent tags comprise tags included at a time of creation of respective content and user profile.

21. The system of claim 20, wherein the processor is further configured to convert an inherent tag to an inherited tag based on a correlation between the inherent tag and one of the user profile and network content, wherein the inherited tags comprise one of the added one or more user tags and the added one or more content tags.

22. The system of claim 21, wherein the processor is further configured to convert an inherited tag to an inherent tag based on a correlation of the inherited tag to one of the user profile and network content.

23. The system of claim 20, wherein the processor is configured to add the inherent tags of the user profile to the list of content tags in response to receiving the indication of selection.

24. The system of claim 20, wherein the processor is configured to add the inherent tags of the selected item to the list of user tags in response to receiving the indication of selection.
